(19) United States
(12) Patent Application Publication
(10) Pub. No.: US 2003/0103592 A1
(43) Pub. Date: Jun. 5, 2003

(54) Model for photons, protons, neutrons atoms and the universe

(76) Inventor: John R. Ross, Del Mar, CA (US)

Correspondence Address: Ross Patent Law Office, P.O. Box 2138, Del Mar, CA, 92014, US

(21) Appl. No.: 10/161,823

(22) Filed: Jun. 3, 2002

Related U.S. Application Data
(63) Continuation-in-part of application No. 09/008,297, filed on Jan. 16, 1998, now abandoned.

(51) Int. Cl. G21G 1/00

(52) U.S. Cl. 376/156

(57) ABSTRACT

Model of photons, electrons, protons, neutrons and atomic nuclei and provides a process for analyzing light and other radiation, subatomic particles, atoms, molecules and the entire universe and its evolution. The present invention also discloses two new “things” that are offered as the basic building blocks of everything in the universe. These things are called “trons”. There are two types of trons, a plus tron and a minus tron. Trons have no mass but they have a charge equal to the electron charge of about +1.6×10⁻¹⁹ Coulomb for the plus tron and about −1.6×10⁻¹⁹ Coulomb for the minus tron. Six trons (such as the trons making up three photons [each photon comprised of a plus tron and a minus tron] combine to produce a single positron and a single negatron. The positron is modeled as a minus tron orbited by two plus trons and a negatron (the negative electron) is modeled as a single plus tron orbited by two minus trons. A model of a proton is proposed that is comprised of only electrons (i.e., three positrons and two negatrons). A positron is orbited by two negatrons in orbits so tight that the orbit speeds of the negatrons is very very close to the speed of light causing increases in the mass of each of the electrons (about 900 times) sufficient to approximately match the known mass of the proton of about 1.67×10⁻²⁷ kg. Two more positrons orbit the center threesome farther out at radii corresponding to the known proton radius. Thus, the three positrons and the two negatrons give the proton its mass of 1.67×10⁻²⁷ kg and its charge of plus one. The plus one charge is also produced by adding the 8 plus trons and the 7 minus trons which make up the proton. The neutron is simply a proton with a negatron in very close orbit.

This Application is a Continuation-in-Part Application of Ser. No. 09/008,297, filed Jul. 17, 2001. This invention relates to processes for analyzing nature, for modeling light and subatomic particles and their inter-reactions, and for modeling the universe and its evolution.

### BACKGROUND OF THE INVENTION

### What We Are Made Of

Since civilizations first developed the smartest men in the world have sought to explain what we and the rest of the universe are made of. Scientist have discovered that the observable universe seems to be comprised of atoms each of which comprises a nucleus having a positive charge surrounded by one or more electrons each having a negative charge. There is general agreement among leading nuclear scientists that the nuclei of all atoms except H¹ consists of protons and neutrons, the H¹ isotope having only a single proton and no neutron in the nucleus. (The nuclei of the H² and H³ isotopes of hydrogen are believed to contain one and two neutrons respectively in addition to a single proton.) In prior art models charge neutral atoms have a number of negative electrons surrounding the nucleus equal to the number of protons in the nucleus and that number determines to chemical properties of the atom. Scientists generally believe that the hydrogen in the universe was created shortly after a “big bang” which occurred at the origin of the universe and that some helium was also created during this very early stage of the evolution of the universe by the fusion of hydrogen atoms. There is a generally accepted belief that all other naturally occurring elements in the universe were created by fusion processes in large stars which later on explode to scatter the elements widely in the universe. These elements then later collect together to form objects such as planets, one of which is the Earth.

Electrons—Positrons and Negatrons

The word “electron” can be used to refer to only negative electrons or it can be used more generally to refer to either negative or positive electrons. Most of us are very familiar with negative electrons which orbit atomic nuclei. A “positron” is a positive electron. Another name for the negative electrons is “negatron”. A positron has a mass equal to the mass of a negative electron and a charge opposite that of the negative electron but equal in magnitude. When the term “electron” is used later in this specification, its meaning will be clear so long as the reader understands that the word has these two possible meanings.

### The Size of Things

Experiments indicate that the size (distance across) of a typical atom is about 10⁻¹⁰ meter. The size of the nucleus of a typical atom (such as sodium with 26 proton and 26 neutrons) is about 10⁻¹⁴ m or about 1/10,000 the size of the atom. The size of a proton is about 10⁻¹⁵ m. The size of an electron is not known for certain but scattering experiments indicate that electrons are smaller that 10⁻¹⁸ m, and some sources indicate that they may be point-like. A diameter of 10⁻¹⁸ would make the electron about 1,000 times smaller than a proton. Its mass is about 1800 times smaller than the mass of a proton.

### Charges

A negative electron (negatron) has a negative charge of about −1.6×10⁻¹⁹ Coulomb and a positive electron has a positive charge of about +1.6×10⁻¹⁹ Coulomb. The prior art teaches that a proton has a positive charge of +1.6×10⁻¹⁹ C. Since neutral atoms have an equal number of positive protons in the nucleus and surrounding negative electrons (negatrons); at distances greater than atomic dimensions, the neutral atom has no charge that is apparent to us.

### Photons

In the prior art a photon is believed to be a quantum of electromagnetic radiation. A photon has energy equal to its frequency multiplied by Plank's constant. A photon is believed to be a stable elementary particle of zero charge traveling at the speed of light. Virtual photons are believed to be exchanged between charged particles and are believed to carry electromagnetic force. The photon's energy is equivalent to mass according to Professor Einstein's famous equation, E=mc².

### Creation of Mass

Pair production is an event in which a gamma ray photon with energy in excess of 1.02 MeV interacts with matter to create a negatron—positron pair. The “rest mass” of a negatron is 9.1100×10⁻³¹ kilograms that in energy units is equal to 0.511 MeV. The rest mass of the positron is exactly the same as that of the negatron. It is also known that the combination of a positron and a negatron results in the annihilation of both of them with the release of two high-energy photons. This creation and annihilation is well documented, but the prior are does not provide a good explanation as to what actually takes place in either case.

### Composition of Little Things

The prior art does not provide a good physical description of either photons or electrons. Photons are treated as particles in some cases and as waves of electromagnetic radiation in other cases. There have even been attempts in the prior are to apply wave characteristics to electrons. Electrons are normally treated as charged particles; however, most modem descriptions of atoms treat the electrons in the atoms as if they were some sort of cloud orbiting the nuclei.

### Quarks

Modern nuclear scientists have tried to explain the structure of protons and neutrons. There is a general belief that protons and neutrons are comprised of particles they call “quarks”. They think that there are various types of quarks including “u-type” quarks and “d-type” quarks. The idea is that protons and neutrons are made up of three quarks each. The proton is supposed to be comprised of two u-type quarks and one d-type quark. The neutron is supposed to be comprised of two d-type quarks and one u-type quark. Since the u-type quarks are suppose to have a charge of 2 e/3 and the d-type quarks a charge of −e/3 (where e is the magnitude of the electron charge), the net charge of the proton is +e and the net charge of the neutron is zero. No isolated quark has ever been observed. (See, for example, Chapter 15, pages 608-651, Modern Physics, Second Edition, Serway et al, Saunders College Publishing, for a general discussion of these issues, especially page 633.) Nevertheless, most leading nuclear physicists apparently have accepted this concept of quarks as truth.

### Masses

As stated above, the rest mass of an electron (positive or negative) is 9.1100×10⁻³¹ kg (or 0.000911×10⁻²⁷ kg). The mass of a proton at rest is about 1.6726×10⁻²⁷ kg and the rest mass of a neutron is about 1.6750×10⁻²⁷ kg. The combined mass of a proton and an electron is about 15×10⁻³¹ kg less than the mass of a neutron. According to Einstein's theory of relativity the mass of a particle increases as its velocity increases according to the following relationship:

$$m = \frac{{m}_{0}}{\sqrt{1 - {( v / c )}^{2}}}$$

where v is the velocity and c is the speed of light.

### Atomic and Nuclear Forces

### Forces on Orbiting Electrons

The electrical force between charged particles is governed by Coulomb's Law and is defined by the following equation:

$$F = \frac{{q}_{1} {q}_{2}}{4 {πϵ}_{0} {r}^{2}}$$

The ratio ¼ e₀=9.0×10⁹ Nm²/C² and the radius r of the hydrogen atom is about 5.3×10⁻¹¹ m. Therefore, (making the assumption that the electron is orbiting at the outer region of the atom and the proton is at the center) the attractive force between the proton and the electron in the hydrogen atom is about:

F=8.2×10⁻⁸N

The electron is not pulled into the nucleus. Why this is so is not completely understood. In the Bohr atomic model electrons are merely assumed to be confined to one of several specific obits. Another answer is that the electron orbits at an orbital velocity great enough so that the centripetal force on it exactly matches the attractive electrical force. Centripetal force is:

$$F = \frac{{mv}^{2}}{r}$$

If this is correct, the velocity of the electron would be about:

$$v = \sqrt{F \frac{r}{m}} = \sqrt{\frac{( 8.2 \times {10}^{- 8} N ) ( 5.3 \times {10}^{- 11} m )}{9.1 \times {10}^{- 31} kg}}$$

$$v = 2.18 \times {10}^{6} m \text{/} s .$$

This is a very large velocity (2.18 million meters per second), almost 1 percent the speed of light. In any event the Bhor atomic model is not currently accepted by leading physics experts. The modem thinking as stated above is that the electrons surrounding the nucleus should not be thought of as being in a defined orbit, but instead some sort of electron cloud or probability density is suggested.

Experiments have shown that the exponent of r (i.e., 2) in the Coulomb equation is very accurately 2.0000 for dimensions down to 10⁻¹⁴ m. However, there is a current belief that in nuclei forces between charged particles do not obey this equation. (See Parker, Concise Encyclopedia of Science and Technology, 3^{rd} Ed., McGraw Hill, p. 492.)

### Forces in the Nucleus

In all atoms except hydrogen atoms, there are multiple protons closely packed in the nucleus along with a roughly equal number of neutrons. Thus, these protons are believed to exert tremendous repulsive forces against each other as suggested by the following example of two protons separated by 4.0×10⁻¹⁵ m, which is a typical nucleus dimension:

$$F = \frac{{q}_{1} {q}_{2}}{4 {πϵ}_{0} {r}^{2}} = \frac{( 9.0 \times {10}^{9} {Nm}^{2} / {C}^{2} ) {( 1.6 \times {10}^{- 19} C )}^{2}}{{( 4.0 \times {10}^{- 15} m )}^{2}}$$

$$F = 14 N$$

A force of 14 N is equivalent to about 3.2 pounds, this force acting on the two protons each of which has a mass of only 9.1×10⁻³¹ kg should cause the protons to fly apart with enormous velocities. This typically does not happen. There is a current belief among the most knowledgeable nuclear scientists that there must be some other force acting in the nucleus to hold it together. Scientists call this force the “strong force”. The Applicant is not aware of any specific proof of this “strong force”. Nevertheless most leading nuclear scientists apparently have accepted this concept of this strong force.

### Unanswered Physics Questions

As additional background for the present invention Applicants includes the following excerpts from the very popular physics set, Feynman, Lectures on Physics, Addison Wesley, Vol. II, p 1-2, 8-6&7, 20-9&10:

“What holds the nucleus together?” In a nucleus there are several protons, all of which are positive. Why don't they push themselves apart? It turns out that in nuclei thee are, in addition to electrical forces, non-electrical forces, called nuclear forces, which are greater than the electrical forces and which are able to hold the protons together in spite of the electrical repulsion. The nuclear forces, however, have a short range—their forces fall off much more rapidly than 1/r² . . . . . We may ask, finally, what holds a negatively charged electron together (since it has no nuclear forces). If an electron is all made of one kind of substance, each part should repel the other parts. Why, then, doesn't it fly apart? But does the electron have “parts”? Perhaps we should say that the electron is just a point and that electrical forces only act between different point charges, so that the electron does not act upon itself. Perhaps. All we can say is that the question of what holds the electron together has produced many difficulties in the attempts to form a complete theory of electromagnetism. The question has never been answered. (imphasis added)

[A] big program was started for the study of the scattering of protons, in the hope of finding the law of force between [neutrons and protons]; but after thirty years of effort, nothing has emerged. A considerable knowledge of the force between proton and proton has been accumulated, but we find that the force is as complicated as it can possibly be. What we mean by “as complicated as it can be” is that the force depends on as many things as it possibly can . . . . There is, however, one important way in which the nucleon forces are simpler than they could be. That is that the nuclear force between two neutrons is the same as the force between a proton and a neutron, which is the same as the force between two protons! If, in any nuclear situation, we replace a proton by a neutron (or vice versa) the nuclear interactions are not changed. The “fundamental reason” for this equality is not known.

I have no picture of [the] electromagnetic field that is in any sense accurate. I have known about the electromagnetic field a long time—I was in the same position 25 years ago that you are now, and I have had 25 years more of experience thinking about these wiggling waves. When I start describing the magnetic field moving through space, I speak of the E- and B fields and wave my arms and you may imagine that I can see them. I'll tell you what I see. I see some kind of vague shadowy, wiggling lines—here and there is an E and B written on them somehow, and perhaps some of the lines have arrows on them—an arrow here or there which disappears when I look to closely at it. When I talk about the fields swishing through space, I have a terrible confusion between the symbols I use to describe the objects and the objects themselves. I cannot really make a picture that is even nearly like the true waves. So if you have some difficulty in making such a picture, you should not be worried that your difficulty is unusual.

### The Need

Prior existing descriptions of the basic building blocks of the universe are not satisfactory. What is needed is a simpler unifying description of the particles making up the universe and a description of processes for forming photons, protons, neutrons, nuclei, atoms and the universe and techniques and processes for confirming or disproving this simpler unifying description.

### SUMMARY OF THE INVENTION

The present invention provides simple models of photons, electrons, protons, neutrons and atomic nuclei and provides a process for analyzing light and other radiation, subatomic particles, atoms, molecules and the entire universe and its evolution.

### Basic Building Blocks of the Universe

The present invention also discloses two new “things” that are offered as the basic building blocks of everything in the universe. I call these things “trons”. There are two types of trons, a plus tron (which I also call a “petron”) and a minus tron (which I also call a “netron”). Trons have no mass but they have a charge equal to the electron charge of about +1.6×10⁻¹⁹ Coulomb for the plus tron and about −1.6×10⁻¹⁹ Coulomb for the minus tron. (Since the entire universe is made from these trons and since they have nothing but charge, I have decided that their charge should rate its own unit. I have egotistically picked “Ross” for the unit. So the charge of one plus tron is 1 Ross. The charge of a minus tron is −1 Ross. The charge represented by two closely spaced plus trons is 2 Ross. There is no such thing as a fractional Ross, since there are no fractional trons. This is quantum stuff. The plural of Ross is Ross. One Coulomb is approximately equal to 6.25×10¹⁸ Ross.)

### Photons

In a preferred embodiment of this invention photons are modeled as a single plus tron and a single minus tron orbiting at the photon frequency about a common center in an orbit plane and being driven by the Coulomb forces of the charges at a speed of light in the photon direction perpendicular to the orbit plane. I have not figured out the orbit diameter of the photon, but it is probably a substantial fraction of the photon wavelength.

### Electrons—Positrons and Negatrons

Six trons (such as the trons making up three photons [each photon comprised of a plus tron and a minus tron] combine to produce a single positron and a single negatron. The positron is modeled as a minus tron orbited by two plus trons and a negatron (the negative electron) is modeled as a single plus tron orbited by two minus trons. The same forces (i.e., the tron's own charges) that propelled the two trons (of opposite sign) comprising the photon in a substantially straight line at the speed of light, in the positron and the negatron propel the two orbiting trons (having the same sign) in two perfect circles on a perfect sphere about the inner tron. This model suggests an explanation for the enormous stability of electrons and positrons in all situations except one. When they run into each other they annihilate each other releasing the trons which pair up to produce photons that shoot off at the speed of light.

### Protons and Neutrons

A model of a proton is proposed that is comprised of only electrons (i.e., three positrons and two negatrons). A positron is orbited by two negatrons in orbits so tight that the orbit speeds of the negatrons is very very close to the speed of light causing increases in the mass of each of the electrons (about 900 times) sufficient to approximately match the known mass of the proton of about 1.67×10⁻²⁷ kg. Two more positrons orbit the center threesome farther out at radii corresponding to the known proton radius. Thus, the three positrons and the two negatrons give the proton its mass of 1.67×10⁻²⁷ kg and its charge of plus one. The plus one charge is also produced by adding the 8 plus trons and the 7 minus trons which make up the proton. The neutron is simply a proton with a negatron in very close orbit.

### Atomic Nuclei

This model models atomic nuclei as protons and neutrons held together at nuclear distances in Coulomb force wells. Since, at nuclear distances, the proton charge is five separate discrete charges, three plus and two minus, protons and neutrons can orient themselves so that they attract each other in force wells with strong Coulomb forces (not “the strong force”). On both sides of the wells, the protons repel each other. The neutron is also repelled as it gets too close. This preferred model models the proton an neutron in the nucleus as equivalent. It assumes that the neutron's extra electron is shared throughout the nucleus.

### Atoms and Molecules

The model of the present invention proposes in accord with prior art thinking that atoms and molecules are made up of protons and neutrons in the nuclei with electrons in orbits. The larger atoms are produced by the fusion of nuclei of smaller atoms or the capture of neutrons.

### Electric Current

The present invention proposes that the flow of current in both direct current circuits and in alternating current circuits is for the most part the flow of plus trons and minus trons. Because of their zero mass and point volume they can travel at a large fraction of the vacuum speed of light through a copper wire. However, when they arrive at their destination each one contributes a charge equal to a negative electron or a positive charge.

### Thermal Energy

The present invention predicts that thermal processes are for the most part produced by action of plus and minus trons that are temporally captured within atomic and molecular structures. And that it is the flow of trons (either as radiant heat flow [thermal photons] or as conduction and convection) that we perceive as heat energy flow.

### Models

The present invention provides physical and computer models representing trons, photons, electrons, nuclei atoms and molecules. These models can be combined to describe anything in the universe and the universe itself.

### Analytical Process

Preferred embodiments of the present invention include processes for analyzing forces acting in atomic nuclei. Embodiments of the present invention can be utilized to analyze hydrogen thermonuclear reactions. The present invention also provides a process for attempting to create protons is in a particle accelerator. The present invention also provides models for analyzing electric current flow, heat flow and electromagnetic radiation. In fact, if the model and processes of the present invention turn out to be a correct representation of these subatomic particles and charges, all physics and chemistry books and all methods and processes for examining structures, electric currents and forces at atomic and molecular distances will need to be revised.

### Unanswered Questions

The present invention provides a new method of analyzing the universe and everything in it. The model provides simple explanations for some known phenomenon for which previous explanations were unsatisfactory. Theses momdels for the most part are based on thought experiments not actual experiments and Applicant does not have proof of the correctness of the models. The Applicant recognizes that people skilled in this art may be able to show immediately that this model is partly or completely erroneous. If so, Applicant hopes that he finds out soon enough so that he can abandon this application before it is published to minimize his embarrassment. On the other hand, if the model turns out to be correct, it could be an important advancement in human knowledge about the universe we live in.

### BRIEF DESCRIPTION OF THE DRAWINGS

FIG. 1 is a representation of a proton.

FIG. 2 is a representation of a neutron.

FIG. 3A is a representation of an alpha particle minus two negatrons.

FIG. 3B is a representation of an alpha particle.

FIG. 4 is a representation of a portion of an alpha particle.

FIG. 5 is a graph showing forces between particles in a nucleus according to a Ross model.

FIGS. 6A, B, C, D and E are drawings showing features of trons.

FIG. 7 shows a photon in flight.

FIGS. 7A and 7B show features of a photon.

FIG. 8 shows a pair production from 6 trons.

FIGS. 9A and 9B show electron models.

### DETAILED DESCRIPTION OF PREFERRED EMBODIMENTS

The present invention can be described by reference to the drawings.

### The Universe Modeled as Nothing But

### A Very Large Number of Plus and Minus Charges

The present invention is based on Applicant's discovery that the universe may be modeled as completely made of nothing but a very large number of point charges of zero mass, one of them a plus charge and one of them a minus charge. Applicant calls the charges “trons”. The plus tron (also called by Applicant a “petron”) has a charge equal to the charge on a proton or a positron, i.e., a charge of about +1.6×10⁻¹⁹C, and the minus tron (also called a netron) has a charge equal to the charge on a negative electron, i.e., a charge of about −1.6×10⁻¹⁹C. Applicant prefers to use 1 Ross as the unit charge. Thus, the charge of a plus tron is +1 Ross and the charge of a negative tron is −1 Ross.

### Trons

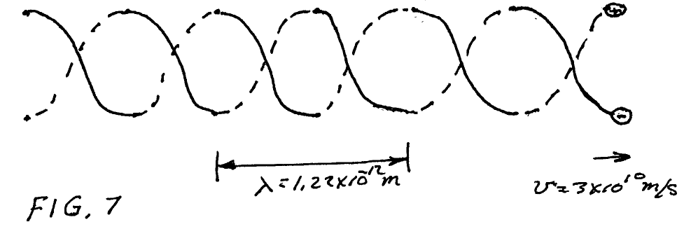

FIG. 6A is a representation of a tron at rest (although trons normally are not at rest). A tron is a point charge with the point at 20. The tron exerts attractive and repulsive force on all other trons in the universe. However, these forces are not instant. In this model the forces both attractive and repulsive travel out together from the tron at a velocity that in preferred models is equal to the speed of light. Thus concentric circles 22 around the point charge represents these force effects and each circle represents a time increment. They are shown in two dimensions but the reader should understand that the forces travel spherically. The forces exerted between two trons obey the Coulumb Law, F=q²/r². The force is attractive if the trons have opposite signs and repulsive if they have the same sign. Trons are almost always in motion, being pushed about by the net forces on them. Since the trons have zero massthey can move faster than the speed of light and very often do. FIG. 6B shows the tron moving at the speed of light. The tron at time zero (now) is shown at 24. The distance between spots on the drawing represents distance traveled in a time interval At. The spot 26 represents the position of the tron at t=−9 and the largest circle 28 represents the force at t=0 resulting from forces emanating from the tron at t=−9. As indicated by arrows 30 the force is repelling for like trons and attractive for opposite trons. The string of arrows at 32 show that the attractive force of a moving tron can take on an arc shape. The reader should note that only nine circles are shown but the number of circles could be continued infinitely. The reader should note that the tron moving at the speed of light exerts no force, attractive or repulsive on the upstream side of plane 34.

### What Happens when Opposite Trons Meet

According to this preferred model, an intersection of two opposite trons often results in the formation of a photon. FIG. 6C is a depiction of two opposite trons traveling in opposite directions, each at the speed of light. The plus tron first feels the attraction of the minus tron when the plus tron is at location 36A when the negative tron in located at 38A but the attractive force of the negative tron which the positive tron feels emanated from the negative tron when it was located at 36B. The two trons rapidly form into a circle each being attracted to the other at a point back on the trail of the other. FIG. 6D depicts two trons in orbit in a circle 40 around a common center. The dots on the circle represent the trail of the two trons at nine time intervals. The position of each tron at t=0 is shown at 40A and 40B. Circles 42 show the cross section of the force spheres of the 40B tron and arrow 44A shows the 40A tron being attracted to point where the tron 40 B was located at t=−9. The reader should notice that if we assume the force effect travels at the same speed as the trons, the direction of the forces will be the same relative to the arc of the circumference of the orbit regardless of the size of the circle. This model thus predicts that all photons have the same geometry, i.e., they have the same shape regardless of frequency. So X-rays should look just like blue light except its circle is much smaller.

What if trons meet head on? Applicant is certainly not certain. I speculate that they either never meet head on or if they do that they pass through each other. Since trons push themselves at the speed of light (which is awfully fast for a massless point) the probabililty of a head on collision should be low. Further, there is no attraction in the directly ahead direction. In addition, if two opposite trons each going the speed of light were to meet head on each would be attracted to a point behind the other. This may cause them to pass through each other. My speculation is that all of the trons produce during the big bang are still with us and will be with us until the end of the universe or even beyond that!

### The Photon

FIG. 6E is a drawing representative of a photon with the plane of the page corresponding to its rotation plane and the plane of rotation is moving at a speed of light. The photon in this preferred model consists of a plus charge 30 equal to about +1.6×10⁻¹⁶ C and a minus charge 32 of about −1.6×10⁻¹⁶ C. This particular photon is a 1.02 mev pair production photon. This energy corresponds to a photon frequency of:

f=E/h=1.02mev/4.14×10⁻²¹mev.s

f=2.46×10²⁰/s.

It has a wavelength λ=1.22×10⁻¹² m, and a period, T=1/f=4.08×10⁻²¹ sec.

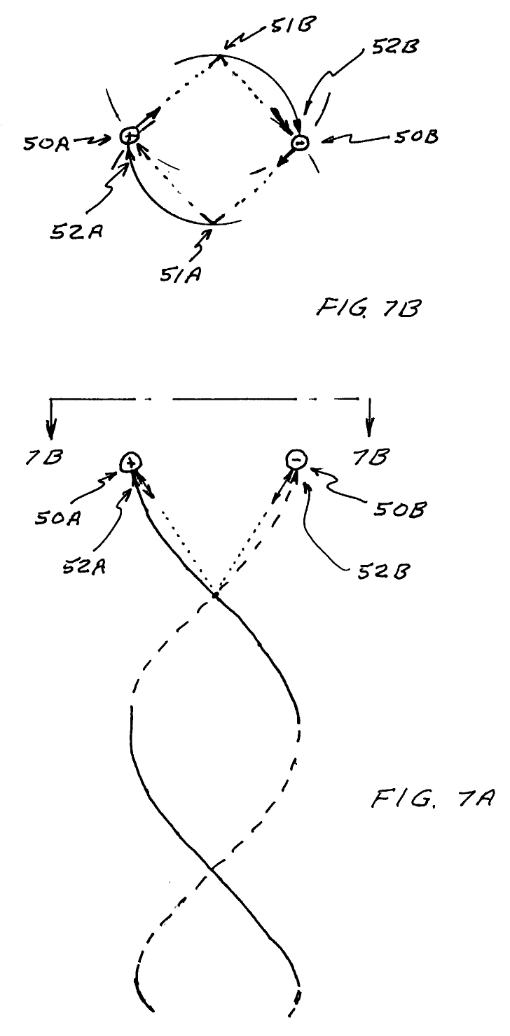

FIG. 7 shows a side view of the photon trail through the universe. The tracts on the front side of the trail are shown solid and the backside is shown dashed. The trail resembles a barber pole with each of the two orbiting charges completing an orbit in a time, T=4.08×10⁻²¹ sec, and progressing forward in the direction of the photon perpendicular to the plane of orbit at 3×10⁸ m/sec and moving forward 1.22×10⁻¹² m each orbit. In order for the plane of the orbit to move at the speed of light, the individual trons must move faster than the speed of light. This is possible in this model because the trons have zero mass.

### Diameter and Speed of the Photon Orbit

According to this preferred photon model the orbit plane of the photon moves forward at the speed of light, so the speed of the trons in the orbit plane must be significantly greater than the speed of light. Their absolute speed and diameter is probably easy to figgure out, but I have not yet done it. My guess is that the orbit diameter is equal to a substantial fraction of the wavelength of the photon. These photons apparently have traveled around the universe at the speed of light since soon after it began, gradually losing energy over the billions of years. They must be enormously stable things! For electromagnetic wavelengths much longer than these, like radio waves with wavelengths in the range of meters and many meters, it is difficult to imagine that they travel as orbiting charges, but maybe they do. (Applicant expects that radio waves do not travel as photons. They may be explained as huge numbers of plus trons and minus trons alternately kicked out of a radio antenna at the frequency of the transmission.

### Photons are Self-Propelling

In this preferred embodiment, photons propel themselves across the universe! Based on the model, the attractive and repulsive forces travel out from the trons at the speed of light. Since trons have no mass any force acting on them will accelerate them instantly until the force ceases or until a counter force is applied. In our model each of the two trons moving helically at greater than the speed of light will feel the force of the other tron and also will feel its own force that moves at the speed of light but catches up with the tron because the tron is moving hellically while the force is moving in all directions at the speed of light. These forces are shown in FIGS. 7A and 7A. The two trons are shown at 50A and 50B at t=0. Their positions at t=−¼T (i.e., ¼ period into the past) are shown at 51A and 51B and their positions at t=−T are shown at 52A and 52B. The Coulomb forces emanating from the positive tron 50A one-forth period ago pushes upward and outward on tron 50A and pulls inward and downward on tron 50B. Conversely forces from tron 50B one-forth period ago pulls downward and inward on tron 50 A and pushes upward and outward on tron 50 B. In addition tron A's immediate past pushes it upward and tangentially as shown at 52A. The same is true for tron 50B as shown at 52B.

### Unanswered Questions

Applicant has attempted to relate this model of photons to known optical phenomenon such as minimum focal spot as a function or wavelength, refraction, reflection interference and polarization. Based on Applicants limited expertise in this technology he has not been able to prove that the model is erroneous. However, he has not been able to show substantial support for the model by applying this model to known experience. Applicant will leave this effort to others much more expert in this field. Applicant believes that the model will fit with experimental evidence in these fields.

### Absorption, Transmission and Reflection

When photons intersect with an object they either pass through, get absorbed in it or are reflected. In case of transmission and reflection the wavelength is the same out as in; therefore, there can be no loss of energy. Often the photon is absorbed in the object. In prior art analysis the photon is considered to be a bundle of energy with no charge and in the case of absorption the energy of the photon is assumed to have raised an electron in an atom to an excited state. The prior art explains that when the electron returns to its ground state through one or more jumps it creates photons and they fly out at the speed of light. The prior art does not have a good explanation as to how the atom or the electron is able to create these photons. In the present model a photon (i.e., the two orbiting charges may be captured by an atom or an electron so that the photon's forward motion is stopped but the two charges continue to orbit at the same frequency while at the same time held in a dynamic Coulomb force well in an atom or an electron. This would represent an excited state of the atom. The lifetimes of these excited states are normally very short. In most cases of absorption the photon loses it shape (i.e. its frequency) but the two trons remain temporally attached to the atom making the atom more excited than it was. The trons may then be kicked out later as thermal radiation at a lower frequency.

### Photon Models

Applicant has constructed photon models such as described in FIGS. 7A and 7B using cardboard toilet paper mandrels and also with Plexiglas tubes, string and rods. Persons skilled in computer programming could easily create 3-dimensional computer models of the photon including dynamic models in which the tron charges propel themselves at a slowed-down speed of light.

### The Shape of the Orbits

In the preferred model the orbit of the two-tron photon is circular, but the shape of the orbit could also be modeled as elliptical with the circular orbit as a special case. Potential shapes could possibly include an extremely elliptical orbit almost linear. This may be what perfectly polarized light looks like, but I do not think so. I think all photons have circular orbits, but I could be wrong. The present invention on this issue is flexible. Perhaps some smart reader of this specification will be able to determine whether the orbits must be circular.

### Is our Model Consistent with our Knowledge about Photons?

If this photon model is accurate, since it represents the most basic concepts of nature, all presently known accurate physics principals must be derivable from it. We know that some things we know about photons seem consistent with the model. These include:

1) The size of the photon of the preferred models seems consistent with how closely we can focus light of various wavelengths.

2) We know that photons have no apparent charge, but photons are known to interact with matter having charges. These features are consistent with the present model where each photon has two charges of opposite sign and at distances greater than atomic distances will cancel each other so that the photon appears to have no charge.

3) The photon has energy equal to a constant (Plank's constant) times the frequency. This means that the photon probably does not have a length. (For example, if it had a length how long would it be? One wavelength? Six wavelengths?) This model says that the photon does not have a length. The only thing it has is charge and frequency (and a corresponding wavelength) and a speed. Its frequency determines its energy and equivalent mass.

4) The photon has a mass (or energy) that is proportional to its frequency. If the photon is moving at the speed of light and vibrating with a frequency, then parts of it must be moving faster than the speed of light which is suppose to be impossible. How can that be. This model provides an answer. It says the trons have no mass and that they can be accelerated at or faster than the speed of light with any force. However, if one forces are pushing or pulling the tron in one or more directions in an oscillatory manner and another force wants to direct the tron in different directions, there could be resistance to the force. That is the explanation of mass according to a preferred embodiment of the present invention. So it is the oscillating trons that create the photon's mass! Therefore, our model is consistent with known fact that the photon energy (or mass) is proportional to its frequency.

5) There never has been a good explanation as to how electricity could travel in a copper wire at a large fraction of the speed of light when it is known that the electrons travel at speeds of only a few meters or centimeters per second. Holes (whatever they are suuppose to be) are thought to travel even more slowly. This model says the trons are what travel at a substantial fraction of 3×10⁸ m/s. The trons with zero mass can carry a charge at almost light speed through a copper wire. Thus, this model is not inconsistent with our knowledge of electric current flow.

6) In a laser, a “population inversion” is created in excited atoms. This model explains the inverted population are temporally captured photons (i.e., the two trons continue to orbit each other but instead of being pushed forward by their own charges, but they are both held in orbit inside an atom or molecule by the forces there which overcome their own driving forces). The stream of laser photons passing by applies forces which tend to orient the orbits of the two trons in the direction of the laser beam. A slight hickup in the “excited” atom or molecule releases the photon to join the laser beam. All of the hundreds of well established physics and optical features of photons will need to be successfully tested against this model of the photon if the model is to have general acceptance. The Applicant believes and hopes that students, professors, engineers and scientists around the world will have great pleasure in being the first to demonstrate that each of these known features are consistent with the model. All existing physics rules including Newton's, Maxwell's and Eienstein's equations that work and have been used for many years in solving problems should be derivable from this preferred model if it is correct. On the other hand if the model is faulty; hopefully, it will be quickly proved faulty and forgotten.

### Electrons

Continuing my effort to describe a simple universe, I have developed an electron (positron and negatron) model similar to the proton-neutron model described in the parent application (to this continuation-in-part) submitted last year. Whereas, protons and neutrons were made of positrons and negatrons, I now have developed a model for the construction of electrons (positrons and negatrons) from the same things that make up photons, i.e., trons. Therefore, as described in the summary to this specification, everything is made of trons—and I mean everything! Everything from the light we see, the warmth we feel, the nuclei and electrons of all of the atoms in our bodies and in our galaxy and in all of the galaxies in the universe and the universe itself—all made from combinations of two tiny massless charges—amazing! But back to electrons.

For many years scientists have known that high-energy photons interacting with matter can produce positrons and negatrons. This is called pair production. Also, it is well known that positrons and negatrons will annihilate each other producing “two” high-energy photons. I am not aware of any good prior art explanation or model explaining these events. One would think that it should be obvious that given pair production and positron-negatron annihilation that electrons and photons must be comprised of the same ingredients. However, I have not seen that suggested in any of the 20 to 30 physics books that I have studied recently. That is what my preferred electron model says. One negatron and one positron is made from the six trons (i.e., the composition of three photons).

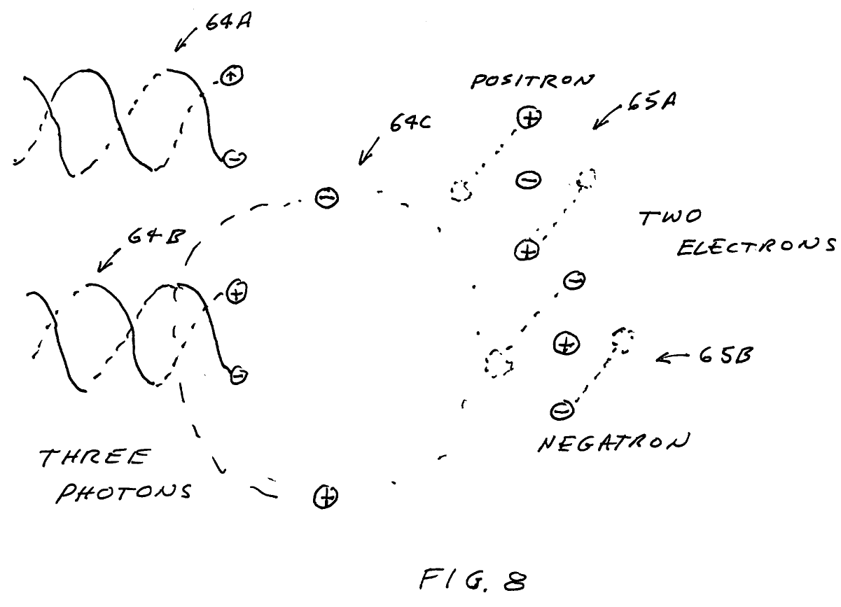

FIG. 8 shows three photons 64A, 64B and 64C combining to form a positron 65A and a negatron 65B. The Applicant is far from certain exactly how these combinations takes place. According to these preferred models of electron formation most of the trons are moving faster than the speed of light before and after the formation of the electrons. In the photon model both trons in each photon are moving forward at the speed of light and in their orbit faster than the speed of light. The center tron in each electron is almost stationary (at least as compared to the orbiting trons) and the two orbiting trons are orbiting at speeds faster than the speed of light.

### The Electron Model

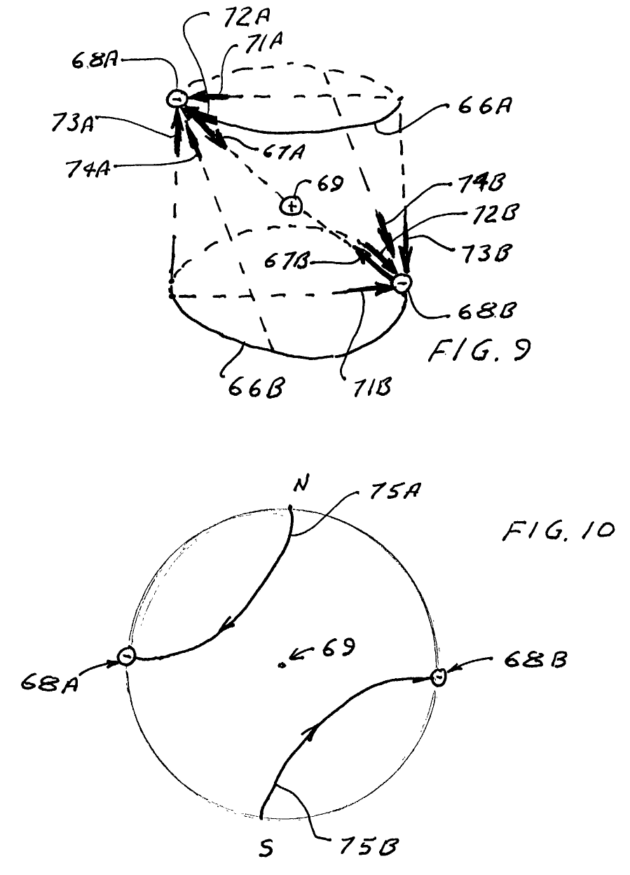

FIG. 9 is a drawing of a preferred embodiment of the present invention. It is a drawing of a model of a negative electron 70 made by Applicant out of Plexiglas, tape and cord and 3/16 inch diameter wooden dowel rods. The cord was glued to Plexiglas sheet to represent tron orbits 66A and 66B. The dowel rods were used to represent Coulomb forces and their directions. Colored tape was used to represent the trons. The forces are as follows: Attractive forces 67 A and B are pulling the two orbiting negative trons 68A and 68B toward positive tron 69 in the center of the electron 70. Four repulsive forces 71-74, A and B combine to counteract attractive forces 67A and B and to push the negative trons in their orbits. Since both negative trons are traveling faster than the speed of light in their orbits they are affected by their own repulsive forces from various points in their past when the repulsive forces moving at the speed of light intersects them on their circular orbits. Each orbiting tron is also affected by the repulsive forces of the other orbiting tron also moving at the same speed in synchrony on the opposite side of electron 70. These forces are also moving at the speed of light and so the forces felt appear to come for the trail of the other orbiting tron rather than the tron itself. The resulting forces push the orbiting trons endlessly along their path about the center tron. The paths in this model form perfect circles on the shape of a perfect sphere. But the diameter of the circles are smaller than the diameter of the sphere. For example, if you think of the electron as a small Earth, and the two orbiting trons were orbiting along the equator; the subsequent path of one of the trons would follow a circular great circle route 75A over the north pole and the other tron would follow a circular great circle route 75B over the south pole. These routes are shown in FIG. 10.

This model of the electron provides an explanation as to why the electron is so stable. I have not yet been able to figure out the radius of the electron, but I believe its radius should be easy to figure out by people with a little better grasp of geometry and forces in motion than I have. My model tells us, however, that it must be much smaller than the proton that has a diameter of about 10⁻¹⁵ m. My guess is that the radius is less than 5×10⁻¹⁹m. This means that the forces holding the electron together and keeping it from collapsing may be millions or billions of Newtons! This is the answer to Professor Feynman's question referred to in the Background section relating to why the electron does not tear itself apart. Coulomb forces hold the electron together. They also prevent it from closing in on itself. As stable as an electron is it is easily annihilated and converted into photons by combining with an opposite electron. My model thus provides a good explanation for the stability of electrons and their ease of annihilation.

### Where Have all the Positrons Gone?

Positrons are rare birds. We do not see many of them. That is because on earth once produced they almost immediately are attracted to an electron and the two are annihilated. If electrons are produced in pairs in pair production by high-energy photons, and also annihilated in pairs, then there should be an equal number of negatrons and positrons in the universe. In my model there is. The missing positrons are contained in protons. This leads us to the model of the proton that was described fairly well by me in my patent application filed almost one year ago in July 2001.

### The Universe may be Comprised of only Electrons—Positrons and Negatrons

The present invention is based on Applicant's discovery the known universe can logically be described as being comprised of nothing more than electrons (i.e., positrons and negatrons), the negatron having a negative charge −e and the positron having a positive charge of +e, and that the only forces acting in the universe is the electrical forces described by Coulomb's Law, i.e.:

$$F \approx \frac{{q}_{1} {q}_{2}}{{r}^{2}}$$

In my prior applications speculated that, “[E]verything in the universe is comprised of combinations of these two simple point-like charges most of which were created in equal number at the time of the “Big Bang” from the electromagnetic energy released in that event.” (Now I speculate that electrons are made of trons; therefore, everything is made of trons.) Protons and neutrons are made of positrons and negatrons, not quarks. Atomic nuclei are made up of positrons and negatrons. The nucleus of each neutral atom contains a number of positrons in excess of negatrons, the difference being equal to the number of orbiting negatrons. There is no strong force. A proton is a combination of three positrons and two negatrons in which two negatrons are orbiting a positron at velocities very close to the speed of light and two additional positrons orbit the central three-some further out to define the size of the proton. The Coulomb force holds the positrons and negatrons of the nucleus together and centripetal force and the Coulomb force combine forces to keep the particles appropriately separated. There probably is no separate gravitational force, but that force that we have believed was gravity is merely another manifestation of the Coulomb force.

### The Proton

### Structure

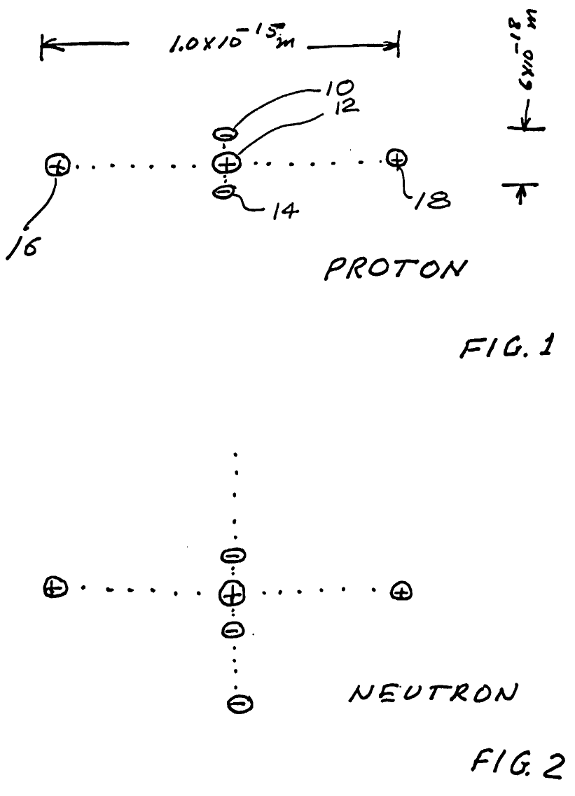

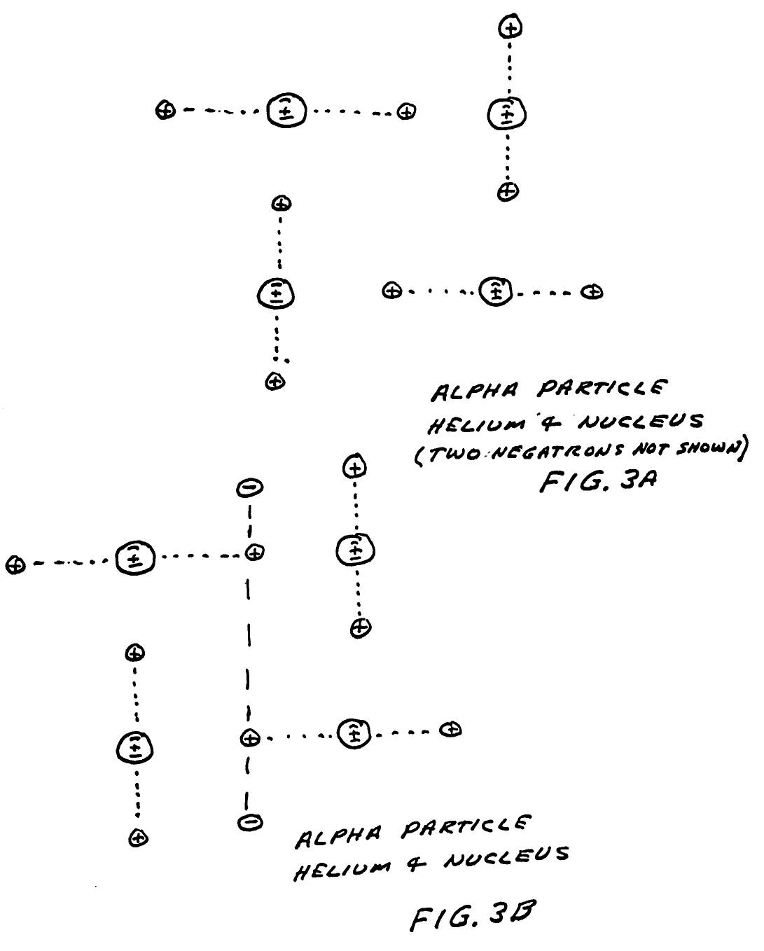

A proton model is proposed that I call the Ross Proton Model. In accordance with this model a proton is comprised of a central three-some consisting of a single positron orbited by two negatrons at extremely large velocities with two more positrons orbiting the central three-some, all as shown in FIG. 1. A neutron has the same general structure as a proton, but an additional electron (as shown in FIG. 2) orbits the two negatrons and three positrons. In the nucleus the neutron's extra electrons are probably shared so that protons and neutrons are probably not distinguishable in the nucleus. As stated in the Background section, it is known that the electron rest mass is 9.1×10⁻³¹ kg and the reported mass of a proton is 1.6731×10⁻²⁷ kg and the reported mass of a neutron is about 1.6754×10⁻²⁷ kg.

### Two Very Fast Moving Negatrons

Most of the apparent mass of the proton and the neutron is accounted for by the two negatrons which are orbiting the center position at a radius of about 3×10⁻¹⁸ m and at a velocity almost equal to the speed of light, i.e., an orbit velocity of about 0.9999994 C which gives each of them an apparent mass of about one half the reported mass of a proton and about one half the mass of a neutron.

### Centripetal Force

To estimate the radii of the orbit of one of these two negatrons 10 orbiting positron 12 as shown in FIG. 1, we equate the electrostatic attractive force between the positron and the negatron which is:

$$F = \frac{{q}_{1} {q}_{2}}{4 {πϵ}_{0} {r}^{2}}$$

and the centripetal force of the very fast orbiting negatron which is:

$$F = \frac{{mv}^{2}}{r}$$

Thus we obtain a rough estimate of r as:

$$r = \frac{{q}^{2}}{4 {πϵ}_{0} {mv}^{2}}$$

Since m ½×1.67×10⁻²⁷ kg=0.835×10⁻²⁷ kg,

q=1.6×10⁻¹⁹C

v 0.9999994C, and

¼ e₀=9.0×10⁹ Nm²/c²:

r=3×10⁻¹⁸ m.

At this radii the Coulomb attractive forces between the orbiting negatron and the central positron is enormous:

$$F = \frac{{q}_{1} {q}_{2}}{4 {πϵ}_{0} {r}^{2}}$$

$$F = 2.5 \times {10}^{7} N$$

The centripetal force is the same:

$$F = \frac{{mv}^{2}}{r}$$

$$F = 2.5 \times {10}^{7} N$$

These calculations are very rough and only produce a general rough approximation of forces and distances. In the above calculations, I have neglected the effects of the second negatron 14 also orbiting the center positron. It has the same velocity as negatron 10 and the forces on negatron are the same as the forces on negatron 14. Negatrons 10 and 14, as they are attracted to positron 12 are repelled by each other with a force of about:

$$F = \frac{{q}_{1} {q}_{2}}{4 {πϵ}_{0} {r}_{2}^{2}}$$

where r₂ is effective separation of negatrons 10 and 14. A force calculation based of a separation between the two negatrons of about 6×10⁻¹⁸ m would produce a repelling force of about 0.64×10⁷ N. However, both are moving at almost the speed of light. Thus, the Coulomb force exerted by each negatron on each other should be somewhat greater than this since each negatron sees the other as being substantially closer than it really is. The faster the negatrons travel the closer the negatron on the opposite side of their orbit appears.

Thus, the two negatrons orbiting the center positron are repelled by each other with a force equal to at least 25 percent of the attractive force exerted by the positron on the two negatrons. It is this repelling force of the two negatrons acting on each other when added to the repelling centripetal force experienced by each that prevents either of them from spiraling into the positron and annihilating the positron and the first negatron to reach it. It may be that this repelling force creates force wells that established the stable orbits of the two negatrons so close but not too close to the central positron.

These three particles, the center positron 12 and fast orbiting negatrons 10 and 14 have a net charge of −1 e and these three particles are orbited by two positrons 16 and 18 at a radius of about 0.5×10⁻¹⁵ m which establish the size of the proton. At this radius the Coulomb attractive force between each of the positrons and the three central electrons (with a net charge of −1.6×10⁻¹⁹C) is.

$$F = \frac{{q}_{1} {q}_{2}}{4 {πϵ}_{0} {r}^{2}}$$

$$F = \frac{( 9.0 \times {10}^{9} {Nm}^{2} / {C}^{2} ) {( 1.6 \times {10}^{- 19} C )}^{2}}{{( 0.5 \times {10}^{- 15} m )}^{2}}$$

$$F = 920 N$$

The positrons orbiting the center three-some must orbit fast enough so that their centripetal force approximately equals the Coulomb forces. Therefore, we can get a rough estimate of that velocity from:

$$F = \frac{{mv}^{2}}{r}$$

$$or : \\ v = \sqrt{\frac{Fr}{m}}$$

If the velocity is much less than c, the mass of the positrons can be assumed to be equal to the positron rest mass, so:

v=2.2×10⁸ m/s

This is about 73 percent of the speed of light and as a result the mass would be increased about 50 percent above the rest mass of 9.1×10⁻³¹ kg or to about 13.6×10⁻³¹ kg which means that the velocity is somewhat less than the above estimate, maybe about ½ the speed of light. This model of the proton has the two positrons 16 and 18 orbiting on substantially the same path on opposite sides of the center three-some. As with the negatrons, the opposing positrons (along with the center positron) help prevent each other from spiraling into the lower orbiting electrons.

Therefore to summarize, the proposed model of the proton that I call the “Ross Proton Model” is shown in FIG. 1. It consists of a positron at a center position with two negatrons orbiting at a radius of about 3×10⁻¹⁸ m so fast that their combined mass is increased to a mass almost equal to the known proton mass. The two positrons orbiting at about 0.5×10⁻¹⁵ account for the rest of the mass of the proton that totals about 1.7×10⁻²⁷ kg. The orbit of the two positrons also establishes the measured size of the proton.

### Quarks

The reader may be wondering at this point how the Ross Proton Model squares with existing proton models. Accelerator experiments show that the proton can be broken apart. When this happens very short-lived particles are produced which decay into positrons and negatrons (plus photons and possibly neutrinos). The Ross Model is supported by this data. This experimental data also indicates (assuming the Ross Proton Model is correct) that the three central electrons are not stable by themselves. That is, they need the two orbiting positrons to help hold them in their very fast path around the central positron. Quarks are supposed to have charges such as +2 e/3 and −1 e/3. At page 633 of Modern Physics referred to above, the authors state: “Despite extensive experimental effort no isolated quark has ever been observed. Physicists now believe that quarks are permanently confined inside hydrons (i.e., protons and neutrons) because of an exceptionally strong force that prevents them from escaping. The Ross Proton Model does not need quarks to explain the construction of protons (or neutrons as explained below). Since no quark has ever been observed, I suspect that they don't exist.

### Neutrons

The Ross Neutron Model is merely a proton with an electron orbiting it. The measured mass of a neutron is greater than the combined mass of a proton and an electron by about 15×10⁻³¹ or about 160 percent of the mass of an electron. This difference can be accounted for by an increased mass associated with an electron velocity of about 0.78 c. This would imply an orbit close to the orbit of the outer two positrons in the Ross Proton Model. Alternately, the electron orbit might be farther out but its presence may cause the two electrons to orbit faster to produce the missing mass. The neutron is not stable, having a half-life of only about 15 minutes. The Ross Neutron Model is shown in FIG. 2. When neutrons are part of a nucleus their extra electron is probably shared more or less equally with the protons in the nucleus.

### Atomic Models

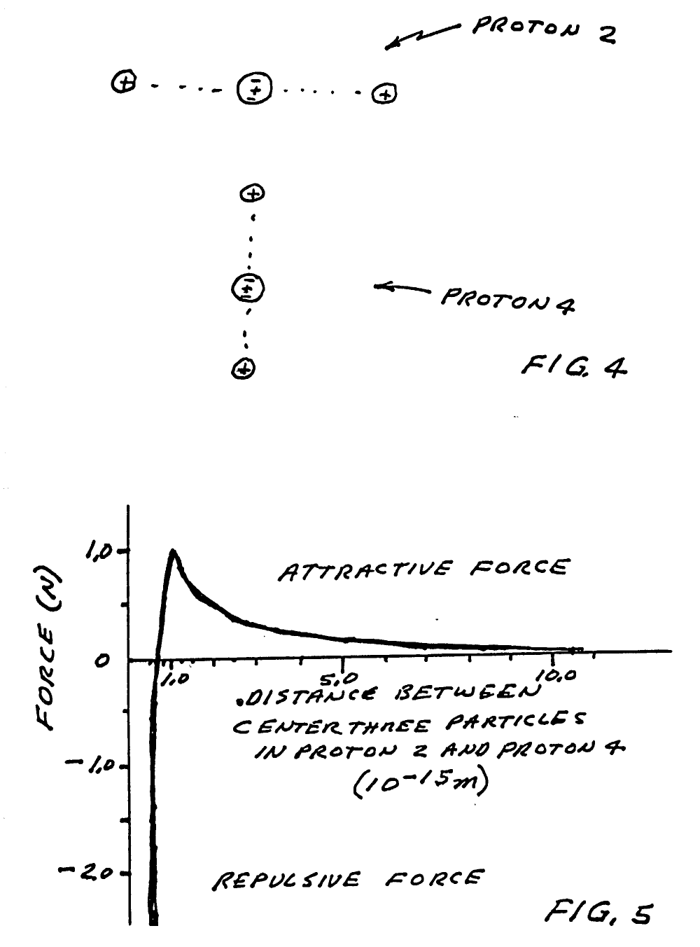

FIG. 3A shows a suggested arrangement of components of a helium 4 nucleus or an alpha particle according to the Ross Nuclear Model with the two extra negatrons (associated with the two neutrons of the helium nucleus) not shown. In this description, I will refer to the group of three positrons and two negatrons shown as shown in FIG. 1 as a “proton” recognizing that the group could have at least initially existed as a neutron with an extra electron orbiting as described above. This liberty is the result of my belief that a neutron (if it is ever identifiable as a separate entity in a nucleus can change places with a proton by having its outer negatron be stolen by a neighboring proton. The missing two negatrons in the FIG. 3A drawing are the outer negatrons of what the prior art refers to as the two neutrons in the nucleus of the helium atom or the alpha particle. Neutrons and protons each appear as five electrons, one positron at the center orbited closely at 3×10⁻¹⁸ m by two negatrons, with this threesome being orbited at 0.5×10⁻¹⁵ m by two positrons. The two extra negatrons are shown FIG. 3B in a close in more or less arbitrary orbit around a central position of the four “protons”. Many orbits of the two negatrons are possible. For example, the negatrons could orbit a single proton or they could orbit any combination of the four protons.

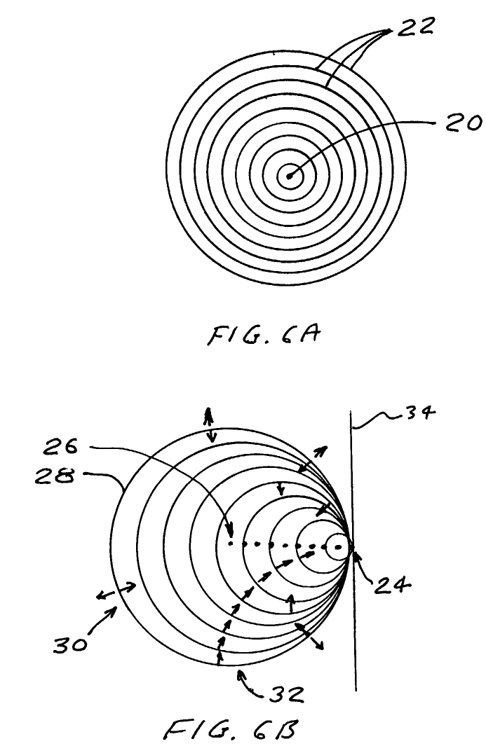

So now let us estimate the forces acting on the protons in this configuration. Remember, the prior art thinking has been that some mysterious God-like “strong force” (which no one could very well explain) must be acting to hold the positive charged protons together in the nucleus. To get a feel for the forces between these protons, let's just consider the forces between the two protons on the left side of the FIG. 3A diagram. These two protons are reproduced in FIG. 4. In FIG. 4 the central positrons and the close-in orbiting negatrons appear as small circles, each with a plus and two minus signs in it. On any scale showing the two inner orbiting negatrons (orbiting at 3×10⁻¹⁸ m) and the two orbiting positrons (orbiting at 0.5×10⁻¹⁵ m) the three inner particles would appear as a tiny spot with a charge of −e while the two orbiting positrons appear as two orbiting spots each with a charge of +e.

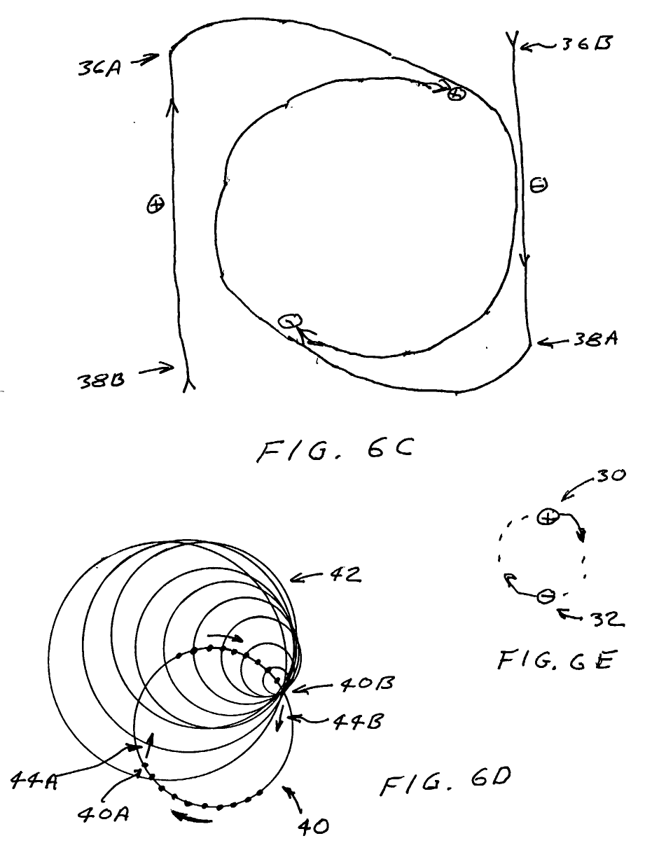

So now on with the Coulomb force calculation. (Remember from the Background section we reported that the prior art thinking was that the Coulomb force between two protons in a larger nucleus separated by 4×10⁻¹⁵ m was a repelling force of 14 N.) However, a close examination of FIG. 4 suggests that with the two protons arranged as shown, with the orbiting planes of the two orbiting positrons of each proton at right angles to each other, at certain distances the net forces of the particles making up the two protons could be attractive at certain ranges of separation and repelling at other ranges. For example at long separations (i.e., very long compared to the dimensions of the protons), the force acting between the protons is repelling since both have a net charge of +e. At very close separation, the closest positron of proton 4 will feel an attraction to the central three particles of proton 2 that is greater than the repulsion to the two orbiting positrons of proton 2. However, as the closest positron of proton 4 moves away from its position shown in FIG. 4, the repulsion from the orbiting positrons of proton 2 will exceed the attractive force of the central three particles of proton 2. Therefore, in the close position, the orbiting positrons of proton 4 will be both attracted and repelled as they make their orbits. The forces acting on the central three particles of proton 4 however would appear to be much more important in determining a stable position of proton 4 relative to proton 2 since their effective mass is about 1000 times greater than that of the orbiting positrons of proton 4. At long distances the central 3 particles of proton 4 feel a net attraction to proton 2, since the central 3 have a net negative charge and the net charge of proton 2 is positive. The closer proton 4 gets to proton 2 the stronger is the attraction of the central three particles of proton 4 to proton 2. However, once the central three particles of proton 4 approach very close to the central three particles of proton 2, the repulsive force due to the central three particles of proton 2 overcome the attractive force of the two orbiting positrons of proton 2 and the force from proton 2 acting on the central three particles of proton 4 becomes repulsive. Therefore, a “force well” is created between the particles of proton 2 and the central 3 particles of proton 4. Once the central three particles of proton 4 are in this well they cannot easily escape. I estimate for example that at a separation of about 0.5×10⁻¹⁵ m between the three central particles of the two protons, the central three particles of proton 4 are very strongly repelled from proton 2, but from about 0.7×10⁻¹⁵ m to about 5×10⁻¹⁵, the central three particles of proton 4 are very strongly attracted to proton 2, with the strongest attraction at a separation of about 1×10⁻¹⁵ μm. The orbiting positrons of proton 4 do not like being so close to the orbiting positrons of proton 2, but they are very light as compared to the central three particles so they are not very determinative of the position of proton 4. Their orbits will be substantially altered from circular as a consequence of the pushing and pulling from the particles of proton 2 as the positrons of proton 4 make their many very quick journeys around the central three particles of proton 4. FIG. 5 is a graph of my very rough estimate of the forces acting between the particles of proton 2 and the central three particles of proton 4.

### Calculation Example

The following is a calculation to estimate the attractive force acting between the central three particles of proton 4 and the particles of proton 2 when the central three particles of proton 4 are located 1×10⁻¹⁵ m from the orbit plane of proton 2. The net force is difference between: (i) the attractive force between central three particles of proton 4 and the two orbiting positrons of proton 2 and (ii) the repulsive force between the central three particles of proton 2 and the central three particles of proton 4.

### Force Exerted by the Particles of Proton 2 on Central Three Particles of Proton 4

When the central three particles of protons 2 and 4 are separated by 1.0×10⁻¹⁵ m, the central three particles of proton 4 are separated from the proton 2 orbiting positrons by about 1.12×10⁻¹⁵ m and each of these positrons attract the three central particles of proton 4 at an angle of 26.5 degrees with the orbit axis of the positrons. (These estimates are based on the assumption that the orbits of the proton 2 orbiting positrons are not changed very much due to the presence of proton 4.) The cosine of 26.5 degrees is 0.894. Thus, the attractive force from proton 2 (due to the pull of the orbiting positrons) on the central three particles of proton 4 in a direction toward the central three particle of proton 2 is:

$$F = \frac{2 {q}^{2} ( 0.894 )}{4 {πϵ}_{0} {r}^{2}} = \frac{( 2 ) ( 9.0 \times {10}^{9} {Nm}^{2} / {C}^{2} ) {( 1.6 \times {10}^{- 19} C )}^{2} ( 0.894 )}{{( 1.2 \times {10}^{- 15} m )}^{2}} = 326.9 N$$

The repulsive force (due to the repulsive force between the center three particles of the two protons) is:

$$F = \frac{{q}^{2}}{4 {πϵ}_{0} {r}^{2}} = \frac{( 9.0 \times {10}^{9} {Nm}^{2} / C ) {( 1.6 \times {10}^{- 19} C )}^{2}}{{( 1.0 \times {10}^{- 15} m )}^{2}} - 230.4 N$$

The net force is:

F=+326.9−230.4=+96.5 N

which is a very strong attractive force.

As indicated above and shown on FIG. 5 if proton 4 approaches proton in the direction shown in FIG. 4, the center three particles of proton 4 will be strongly attracted to proton 2 until the center three particles are within about 1×10⁻¹⁵ m of proton 2 at which time the attraction drops sharply and at about 0.6×10⁻⁵ m the center three particles are repulsed. The center three particles of proton 4 will quickly find its zero force location somewhere around 0.6×10⁻¹⁵ m from the center of proton 2 and will probably oscillate about that zero force position at a very large frequency. As the particle of the two protons approach each other, the orbiting positrons of proton 4 are strongly affected by the positive and negative particles of proton 2 and their orbits will fluctuate wildly until they find an equilibrium orbit.

The other protons of the helium nucleus will arrange themselves in a similar configuration, a possible configuration being the one shown in FIGS. 3A and B. The atoms heavier than helium will have its protons arranged in a manner similar to that shown for helium. It should be relatively easy for persons skilled in this art to construct computer models which would model the Coulomb forces of these particles and would predict the shape of these nuclei including the helium nuclei much more accurately than I have done here with my very simple calculations. These calculation are not intended to be precise. Persons skilled in the art of nuclear physics will be able to greatly improve on my extremely rough calculations. The purpose of these calculations is merely to show that there are potential configurations of positrons and negatrons which can account for the mass, size and charge of protons and neutrons, and that there are configurations of protons and neutrons based on this model that can explain the structure of atomic nuclei.

### Implications of the Ross Nuclear Model

The structure of protons, neutrons, nuclei, atoms, the earth, us and the rest of the universe can be explained very simply without resort to the strong force, quarks and other prior art theories of “modem physics” that the leading writers apparently believe in without proof of their existence. This model also, better than any other example that I am aware of, shows that mass and energy really are the same thing! Positrons and negatrons are generated from a high-energy photon that has energy, a velocity of c but no mass. We also know that when a positron and a negatron collide both may be annihilated with the production of two high-energy gamma rays. Thus, positrons and negatrons are merely packages of stored electromagnetic energy. Protons and neutrons are, in the Ross models, nothing but combinations of these packages of energy. Two of the negatrons are moving extremely fast, fast enough to produce almost all of what we have thought of as the mass of these particles. So we can easily say now that protons and neutrons are nothing but energy. Atoms are made of protons and neutrons along with some orbiting negatrons (also energy) and the masses of all of the things in the universe is made of atoms or parts of atoms. Therefore, we could say, if my model is correct, that the universe is made of only energy. We have known for many years that mass and energy are equivalent. With this model, mass is energy!

This model also is consistent with the notion that for each negatron, there must be a positron. In my model the universe has exactly the same number of negatron as positrons. With this model, believers will have a good time revising theories dealing with the big bang. It is very easy to understand how the energy released in the big bang would have created billions and billions and billions of equal numbers of positrons and negatrons each which quickly would have quickly annihilated one of its opposites or would have combined with four other electrons to form a proton or five other electrons to form a neutron. The protons are extremely stable. Most of them would have soon captured a negatron to form a hydrogen atom. The neutrons would either have combined with a proton or would have quickly decayed to a proton.

Believers also will find it easy to explain the origin of the last big bang and to predict the next big bang. Since we now understand the basic structure of nuclei, we can understand what will happen when all the matter of the universe comes crushing in to almost a single point. This is possible if positrons and negatrons are single points, since there are equal numbers of them and since positrons and negatrons love each other as much as they hate their own kind. Think of the fun we will have calculating the energy released when all of these positrons and negatrons of all the atoms of the known universe are crushed together and annihilate each other.

Eliminating the strong force from the vocabulary of nuclear physicists may cause some to question the gravitation force. I suspect that on close analysis, we will find that the force of gravity is merely another manifestation of the Coulomb force. Under the Ross models we have now a world of energy. Mass is energy, all based on Coulomb forces. I have not figured out how, but I believe that we will find that gravity is the result of Coulomb attraction. The attractive force of atomic nuclei acting on far away orbiting electrons may be more effective than the repulsive force of electrons and nuclei acting on their respective counterparts. This difference in Coulomb effects may be enough to account for the relatively very weak force of gravity.

On a more practical side, believers (if there are any) will want to do some experiments to see if they can make a proton according to the recipe suggested in this specification. This would be to toss into a target space a positron at rest or moving slowly. Then direct two negatrons toward it in almost exactly opposite directions to arrive at the positron at the same time. These negatrons should be traveling at almost the speed of light. Two positrons should also be fired toward the positron from opposite directions and at right angles to the paths of the two negatrons. The two positrons should be traveling at about one half the speed of light and should arrive in the vicinity of the stationary or slow moving positron at the same time as each other and very, very soon after the arrival of the negatrons.

If the Ross Proton Model is correct, it should be apparent that the proton (the hydrogen nucleus) has within it one heck of a lot of energy orbiting around. Therefore, we may want to put some effort into trying to figure out how to release that energy. The energy available is many orders of magnitude greater (for a given amount of hydrogen) than that released in a hydrogen bomb. The current belief is the in a hydrogen bomb two hydrogen nuclei are converted to a helium nucleus. The energy released is the difference in mass of the two hydrogen nuclei and the mass of the helium nucleus. This is a small fraction of the mass of a hydrogen nucleus. If this model is correct all (or almost all) of the mass of the hydrogen nucleus would be released if we could cause it to break apart. If we could knock off one of the orbiting positrons, the remaining particle would probable be unstable and decay rapidly into positron and negatrons flying apart at high speeds or annihilating each other along with the release of gamma rays.

### Correctness of Model Doubted

The model of the proton and the model of atomic nuclei presented above constitute a major departure from the most widely accepted theories explaining the makeup of nuclear particles. If the Ross models are anywhere close to being correct all physics books written during the past 20 years will have to be substantially revised. Applicant recognizes that many of the smartest people in the world have devoted their lives to efforts directed at explaining the makeup of these nuclear particles. If the above models are correct, Applicant finds it very difficult to believe that at least one of those brilliant people would not have developed them long ago. Nevertheless, Applicant has described his models in the very long shot belief that they might be correct or that they are close to correct. He has not had his math checked by any of his very smart friends so he recognizes that the models may be full of stupid embarrassing mistakes. Applicant has presented his nuclear model as a patent application for two reasons: (1) he is a patent attorney (a long time ago he used to be a nuclear engineer) and is familiar with patent applications as a technique for publishing discoveries and (2) a patent application is at least initially kept secret and can be abandoned, so if he learns soon that he has made foolish mistakes, he can perhaps minimize his embarrassment.

### Processes for Testing and Evaluating

### Ross Proton Model and Ross Nuclear Model

Many process for testing and evaluating the Ross Proton Model, the Ross Neutron Model and the Ross Nuclear Model are available. One process is for a person experienced in modern nuclear physics to evaluate the models as they have been presented in this specification. This can easily be accomplished with a hand calculator.

### Computer Models

A more sophisticated evaluation would be to utilize a digital computer model incorporating one or more of the Ross models. It should be fairly simple to model the positrons and negatrons in the Ross Proton Model and determine if the model is stable. If I am right, the Ross proton should be enormously stable. By making the computer model a little more complicated, it should be feasible to determine how hard it would be to make a proton using the technique described above for doing that. Perhaps then the computer model could be extended to predict the formation of protons in the Ross model during the process that followed the big bang. Once the Ross proton and the Ross neutron have been modeled on a digital computer it would be relatively simple to create similar computer models to examine the Ross Nuclear Model. After these models are created investigations could be preformed to determine if a technique can be developed to breakup the proton and release its energy. If this could be done economically, we would have what may be the most important invention since the beginning of civilization.

### Nuclear Tests and Experiments

If computer modeling shows that the Ross models are correct or that modifications or derivations of the Ross models are correct. A next step is to perform some experiments with particle accelerators to test the models or aspects of the models. It may be that current accelerators do not have the capabilities to properly investigate the Ross models. If so and if the models are shown to be possibly correct then perhaps accelerators can be built to properly test the models.

### Trons Deserve Their Own Unit

Applicant believes that if his model is correct and the entire universe is made of these trons, each having a particular charge approximately equal to the values set forth above; the magnitude of that charge should be considered one of the most important things in the world—important enough to rate its own value. And also the other forces at work in the universe all of which will be, one way or other, derived from these charges should be spoken of in terms of the quantity of these charges and not vice versa. Applicant has thus generated a new term that represents the exact magnitude of the charge of a tron. That term is the “Ross” the symbol for a Ross is “R”. Thus, the charge of a plus tron is +1 Ross or +1R. The charge of a minus tron is minus 1 Ross or −1R. The plural of Ross is Ross (like the plural of deer is deer). Therefore, one Coulomb is equal to about 6.25×10¹⁹ R. Since force between charges is the product of the two charges divided by the square of the distance between them, force is expressed as Ross per square meter (R²/m²). Thus, the attractive Coulomb force between a plus tron and a minus tron positioned 5.3×10⁻¹¹ meter apart is equal to 3.56×10²⁰ R²/m². That force in Newtons is 8.2×10⁻⁸ N; thus, one Newton equals 4.34×10²⁷ R²/m².

### No Quarks, No Special Weak Force and No Strong Force

This model shows how nuclei can be held together by Coulomb forces which unquestionably exist. Therefore, there is no need to invent nuclear forces for which there is no proof of existance such as the speical weak nuclear force and the strong nuclear force. Also, since the above model shows how protons and neutrons can be held together in the nuclei of atoms there is no need to invent quarks for which there is no good experimental evidence.

While preferred embodiments of the present invention are described above, the reader should not construe the present invention as limited by the above description. In fact persons skilled in nuclear physics will envision many other possible variations within the scope of the present invention. For example, other models of proton, somewhat more complicated than the one described above may be the true proton model. For example, instead of two negatrons in the close-in orbit there could be four or six with a corresponding four or six positrons in the outer orbit, again to give the proton a plus 1 charge. The basic Ross Proton Model is a proton that is comprised of only electrons, the electrons including a plurality of positrons and a plurality of negatrons, with at least one of said electrons orbiting at least one other of said electrons at a velocity great enough to increase the mass of electrons to equal a proton mass of about 1.67×10⁻²⁷ kg. If the models described above of the proton, the neutron and nuclei prove to be correct, I expect that virtually all phases of nuclear physics will have to be modified to incorporate the present invention. In addition, processes involving many other branches of physics will need to be revised for a correct understanding of the true nature of the atomic structure. The above disclosures may also be useful in processes for analyzing electromagnetic radiation, especially high-energy radiation. Accordingly, the reader is requested to determine the scope of the invention by the appended claims and their legal equivalents and not by the above examples.

I claim:

1) A process for analyzing subatomic particles comprising the steps of:
A) creating a model of a proton comprised of electrons, said electrons including a plurality of positrons and a plurality of negatrons, with at least one of said electrons orbiting at least one other of said electrons at a velocity great enough to increase the mass of said at least one of said electrons so that the mass of all of said electrons equal or approximately a proton mass of about 1.67×10⁻²⁷ kg,
B) programming a digital computer to perform analyses using said proton model.

2) A process as in claim 1 wherein said electrons include:
A) a first positron,
B) two negatrons orbiting said first positron each at a velocity, defining a negatron velocity, very near the speed of light, said first positron and said two orbiting negatrons defining a center three-some, and
C) two positrons orbiting said center three-some.

3) A process as in claim 2 wherein said negatron velocity is about 0.9999994 C, where c is the speed of light.

4) A process as in claim 1 and further including the step of creating a model of a neutron said model of the neutron comprising all of the electrons of the proton and an additional negatron.

5) A process as in claim 4 wherein said additional negatron is in orbit at a velocity large enough to increase its mass by at least 50 percent.

6) A process as in claim 1 and further comprising the steps of creating model of at least one atomic nucleus comprised of a plurality of protons, each of said plurality of protons being comprised of a plurality of positrons and negatrons.

7) A process as in claim 6 and further comprising the step of programming said digital computer to analyze forces acting in said atomic nucleus.

8) A process as in claim 7 wherein said forces are only Coulomb forces.

9) A process as in claim 1 wherein said process further includes a step of using said digital computer to analyze a hydrogen fusion reaction.

10) A process as in claim 9 wherein said fusion reaction is assumed to occur in a thermonuclear explosion.

11) A process as in claim 9 wherein said fusion reaction is assumed to occur in a controlled thermonuclear reaction.

12) A process as in claim 7 wherein said process further includes a step of using said digital computer to analyze a hydrogen fusion reaction.

13) A process as in claim 12 wherein said fusion reaction is assumed to occur in a thermonuclear explosion.

14) A process as in claim 12 wherein said fusion reaction is assumed to occur in a controlled thermonuclear reaction.

15) A process as in claim 1 wherein said digital computer is programmed to analyze the big bang.

16) A process for making a proton comprising the steps of:
A) positioning a positron in a target region of a particle accelerator,
B) directing two negatrons at said target region each at a velocity very close to the speed of light, and
C) directing two positrons at said target region.

17) A process as in claim 16 wherein said two negatrons are directed in directions opposite each other and said two positrons are directed in directions opposite each other.

18) A process for analyzing subatomic particles comprising the step of creating a model of a photon comprised of two mass-less charges.

19) A process as in claim 18 wherein one mass-less charge is positive and the other is negative.

20) A process as in claim 19 wherein said charges are propelled by Coulomb forces from themselves.

21) A process as in claim 18 wherein said model is created using a digital computer.

22) A process for analyzing subatomic particles comprising the step of creating a model of a negative electron comprised of two negative charges orbiting a positive charge.

23) A process as in claim 22 wherein said model is created using a digital computer.

24) A process for analyzing subatomic particles comprising the step of creating a model of a positive electron comprised of two positive charges orbiting a negative charge.
